(19) United States
(12) Patent Application Publication
(10) Pub. No.: US 2019/0235600 A1
(43) Pub. Date: Aug. 1, 2019

(54) COMPUTER SYSTEM HAVING AT LEAST ONE INTERFACE AND METHOD OF RESTRICTING POWER OUTPUT

(71) Applicant: Fujitsu Technology Solutions Intellectual Property GmbH, München (DE)

(72) Inventors: Rainer Staude, München (DE); Andreas Maier, München (DE); Rudolf Häußermann, München (DE); Waldemar Felde, München (DE)

(21) Appl. No.: 16/322,033

(22) PCT Filed: Oct. 17, 2017
(86) PCT No.: PCT/EP2017/076499

§ 371 Date: Jan. 30, 2019

(30) Foreign Application Priority Data
Oct. 24, 2016 (DE) 10 2016 120 226.6

(51) Int. Cl. G06F 1/3206; G06F 1/3296; G06F 13/38

(52) U.S. Cl. CPC G06F 1/3206; G06F 1/3296; G06F 2213/0042; G06F 2213/3812; G06F 13/382

(57) ABSTRACT

A computer system having at least one interface includes at least one voltage monitoring device, and at least one interface control device including a signaling circuit, wherein the interface control device is configured to restrict a power output via the interface to a predetermined power level if the voltage monitoring device detects a drop of a supply voltage of the computer system below a first threshold value, and the signaling circuit is configured to signalize the restriction of the power output to a peripheral device.

### TECHNICAL FIELD

This disclosure relates to a computer system having at least one interface, in particular a USB Type-C interface as well as a method of restricting the power output via at least one interface of a computer system, in particular a USB Type-C interface.

### BACKGROUND

Nowadays, almost all computer systems have interfaces to which peripheral devices can be connected. These interfaces are mostly configured to deliver a supply voltage from the computer system to a peripheral device. In a USB Type-C interface, power of up to 15 W can be output via the interface. According to the Power Delivery Specification, a delivery of up to 100 W is possible via an interface.

In a computer system, the above-described power output can result in power shortages that lead to a system crash. This is particularly true if multiple interfaces are attached to a computer system and, therefore, a multiple of the above-mentioned power values can be tapped. Moreover, power shortages occur if a computer system having such interfaces comprises a power supply unit with a limited output power as with so-called “All-in-one” computers, for example.

In such devices, one possible approach is to limit the power output via the interfaces to a certain fixed value. However, operating peripheral devices on the interfaces that require a higher power output than the limited power output will no longer be possible. This is troublesome in particular in electric devices, the chargeable batteries of which are charged via a USB port. The charging process of a rechargeable battery takes considerably longer with a low power output than with a higher power output.

Another possible approach lies with the reduction or restriction of power consumers in the computer system. The user faces a situation where corresponding properties of the product are no longer available, or can only be operated with limited performance. Another approach is the use of larger power supply units with sufficient power reserves. This causes higher costs and a lower energy efficiency. Moreover, additional space for a more powerful and therefore larger power supply unit is often not available in computer systems of limited volume.

US 2013/0320942 A1 discloses a voltage control circuit with an adaptive power limitation. The voltage control circuit limits a current flowing through the control circuit to keep the input voltage constant. Depending on whether the voltage control circuit is attached to an interface on the side of the host or the side of the peripheral device, either a current delivered to a peripheral device via the interface is limited, or a current received via the interface, which is delivered to the peripheral device having the voltage control circuit installed therein, is limited.

U.S. Pat. No. 5,884,086 describes a device and a method of communicating various voltages and power levels via an interface between a host and a peripheral device. In that example, a peripheral device requests power required by the peripheral device from the host. Then, the host unblocks the power required on the respective interface.

It could therefore be helpful to provide a computer system having at least one interface and a corresponding method for the operation thereof to improve power efficiencies.

### SUMMARY

We provide a computer system having at least one interface, including at least one voltage monitoring device, and at least one interface control device including a signaling circuit, wherein the interface control device is configured to restrict a power output via the interface to a predetermined power level if the voltage monitoring device detects a drop of a supply voltage of the computer system below a first threshold value, and the signaling circuit is configured to signalize the restriction of the power output to a peripheral device.

We also provide a method of restricting power output via at least one interface of a computer system, including monitoring a magnitude of a supply voltage in the computer system, and restricting the power output via the at least one interface to a predetermined power level if a drop of the supply voltage below a first threshold value is detected, wherein the restriction of the power output is signaled to a peripheral device connected to the at least one interface by a signaling circuit.

### BRIEF DESCRIPTION OF THE DRAWINGS

FIG. 1 is a schematic representation of a computer system according to one example.

FIG. 2 is a status diagram of a method of restricting the power output via at least one interface of a computer system.

### LIST OF REFERENCE CHARACTERS

1 computer system
2 interface
peripheral device
4 cable
5 supply line
6 signaling line
7 control voltage
8 power adapter
9 voltage monitoring device
10 interface control device
11 emergency shutdown component
12 voltage supply
13 measuring line
14 first signal line
15 second signal line
16 singling circuit
17 electronic switch
U supply voltage
G1 first threshold value
G2 second threshold value

### DETAILED DESCRIPTION

We provide a computer system having at least one interface. The computer system further comprises at least one voltage monitoring device and at least one interface control device. The interface control device includes a signaling circuit and is configured to restrict a power output via the interface to a predetermined power level if the voltage monitoring device detects a drop of a supply voltage of the computer system below a first threshold value. The signaling circuit is configured to signalize the restriction of the power output to a peripheral device.

Power shortages in the computer system are prevented in that the magnitude of the supply voltage of the computer system is monitored and the power output via the interface is restricted to a predetermined power level if the supply voltage drops. In this way, the power output via the interface is dynamically adapted to the power available in the computer system. Thus, a permanent restriction of the output power at the interface to a minimum, the restriction of the power consumers in the computer system, or the use of a higher supply voltage, which makes the computer system become larger and more expensive, is not required.

Some protocols such as USB Type-C, implement a power output to a peripheral device via an interface in that on the side of the computer system, an available power level is signaled to the peripheral device. Subsequently, the peripheral device adjusts the power received from the computer system according to the signaling. To restrict the power output via the interface to a predetermined power level, the computer system can in this example produce a signal corresponding to the predetermined power level.

Advantageously, the computer system may further comprise a power supply unit that provides the supply voltage of the computer system. The power supply unit includes a power adapter or a battery, for example.

To implement the computer system having at least one interface, a voltage monitoring device is particularly suitable which, if the supply voltage in the computer system drops below a first threshold value, sends at least one first warning signal for restriction of the power output to the interface control device.

The voltage monitoring device may be configured to send a second warning signal to an emergency shutdown component of the computer system if the supply voltage drops below a second threshold value. The emergency shutdown component is configured for the emergency shutdown of the computer system upon receiving the second warning signal. This emergency shutdown prevents an overload of the power adapter that could lead to permanent damage. Such an overload can, for example, occur if the interface control device or other components of the computer system are not properly working. In the event of an emergency shutdown, the computer system is e.g. shut-down abruptly, to avoid damage to installed components.

The interface may comprise at least one supply line and at least one signaling line. The interface control device connects to the at least one supply line and the at least one signaling line. In a USB Type-C interface, the at least one supply line corresponds to the bus voltage line, and the at least one signaling line corresponds to the CC line.

For implementation of the computer system having at least one interface, in particular also at least one interface is suitable that is configured for different power outputs in accordance with the Power Delivery Specification.

We also provide a method of restricting the power output via at least one interface of a computer system, in particular a USB Type-C interface. The method comprises the following steps:

monitoring a magnitude of a supply voltage in the computer system with at least one interface, restricting the power output via the at least one interface to a predetermined power level if a drop of the supply voltage below a first threshold value is detected.

This method dynamically adapts the power of a computer system delivered via an interface in the event of a power shortage. An overload of the computer system due to a tapping of a too large power via an interface is detected by the computer system. Before the overload results in a system crash, the interface control device restricts the power output via the interface and thereby secures the computer system against the overload.

One of a plurality of different, predetermined power levels may be selected for the power output. If a plurality of different, predetermined power levels are available, the power output via the interface can be gradually restricted in a power shortage. This comes with the advantage that, for example, in a minor power shortage, the output power can be restricted by a small value only. A connected peripheral device is provided with power reduced by a small value only. If a major power shortage is detected in the computer system, a power level that corresponds to a significantly higher restriction of power can be selected.

To implement the method, in particular different power levels with a power output of 15 W, 7.5 W and 4.5 W are advantageous. These power levels correspond to the power levels of the USB Type-C specification.

The plurality of different power levels can include a power level, the selection of which causes full interruption of the power output.

The method may include a step of sending a second warning signal if a drop of the supply voltage below a second threshold value is detected, and the computer system, upon receiving the second warning signal, undergoes an emergency shutdown.

The power output via the interface may be temporarily deactivated after the first warning signal has been received by the interface control and before the predetermined power level is provided.

After detecting the drop of the supply voltage, restriction of the supply voltage may be delayed by a time T. If the supply voltage rises again above the first threshold value during this period, the power output continues without restriction. This comes with the advantage that the power output via the interface is restricted only if the supply voltage has been below a first threshold value for a certain period of time. In this way, it is prevented that already a minimal temporary voltage drop in the computer system that does not constitute any harm to the computer system leads to a restriction of the power output.

Further advantages are described in the description of examples. Description of the examples is made by the following Figures.

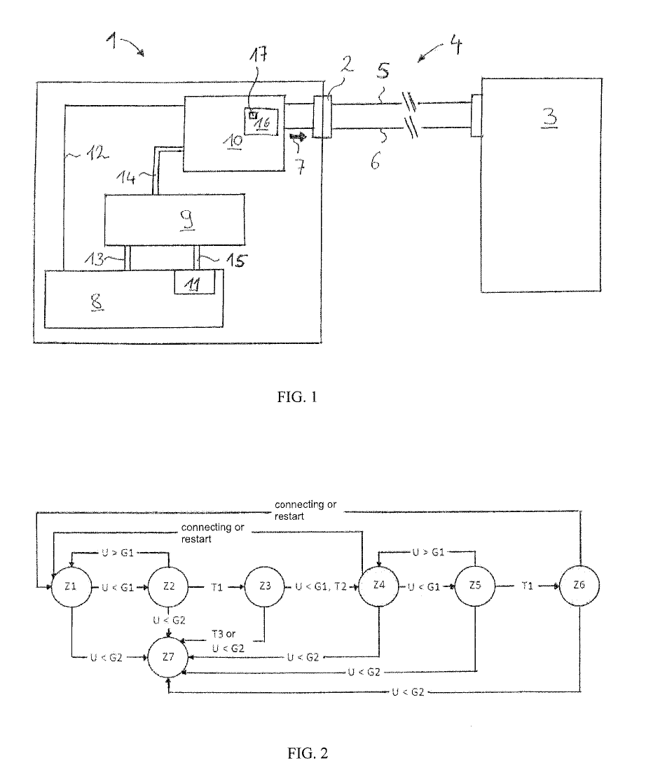

FIG. 1 shows a schematic illustration of a computer system 1 having an interface 2 according to an example. A peripheral device 3 connects to the interface 2 of the computer system 1 via a cable 4. In the described example, the cable 4 is a USB Type-C cable and, among other things, includes a supply line 5 and a signaling line 6. In a USB Type-C connection, the supply line 5 is referred to as bus voltage line VBUS, and the signaling line 6 is referred to as CC line. Other lines that comprise a USB Type-C connection are not illustrated in FIG. 1.

The computer system 1 provides a supply voltage to the peripheral device 3 via the supply line 5. So that the peripheral device knows how much power it may obtain from the computer system 1 via the supply line 5, the computer system 1 applies a corresponding predetermined control voltage 7 to the signaling line 6.

The computer system 1 further comprises a power adapter 8, a voltage monitoring device 9 and an interface control device 10. In the example, the power adapter 8 includes an emergency shutdown component 11. The interface control device 10 is supplied with an operating voltage by the power adapter 8 via a voltage supply 12. The voltage monitoring device 9 connects to the power adapter 8 via a measuring line 13. The voltage monitoring device 9 connects to the interface control device 10 via a first signal line 14, and the emergency shutdown component 11 via a second signal line 15. The interface control device 10 is coupled to the supply line 5 and the signaling line 6 via the interface 2. In addition, the interface control device 10 includes a signaling circuit 16 in the described example.

The peripheral device 3 receives electric power from the computer system 1 via the cable 4. If the cable 4 is plugged-in on the interface 2, or if the computer system 1 is started, the computer system 1 identifies the peripheral device 1, and an unrestricted first power level with a maximum power of, for example, 15 W is signaled by the signaling circuit 16 through the control voltage 7 via the signaling line 6. The peripheral device 3 evaluates the control voltage 7 and adjusts the power obtained from the computer system 1 to a maximum power of 15 W corresponding to the unrestricted first power level.

If power is also output via an additional interface 2, not illustrated in FIG. 1, of the computer system 1 or, if the computer system 1 is operated with a higher load and per se requires a larger part of the maximum available power of the power adapter 8, a power shortage occurs in the computer system 1, and the supply voltage U of the computer system 1 drops. This drop is detected by the voltage monitoring device 9 via the measuring line 13. Then, the device 9 sends a first warning signal to the interface control device 10 via the first signal line 14.

In this example, the voltage monitoring device 9 monitors the operating voltage in the computer system 1. As an alternative, a device can be used that detects a voltage drop in the computer system 1 in that the device monitors a current in the system, or a power.

Upon receiving the first warning signal, signals to restrict the power output via the interface 2 are generated in the interface control device 10. For this purpose, a control voltage 7 is generated in the signaling circuit 16, which voltage is applied to the signaling line 6 via the interface 2. The control voltage 7 unambiguously signals a second power level, e.g. with a power output of 7.5 W, to the peripheral device 3. Thereupon, the peripheral device 3 adjusts the power obtained via the interface 2 to the second power level of 7.5 W. The magnitude of the supply voltage U monitored by the voltage monitoring 9 exceeds the first threshold value G1, for example, a lower threshold value of a tolerance range for the supply of the computer system 1.

If consumption in the computer system 1 increases further as described above, again a drop occurs in the supply voltage U below the first threshold value G1, if the power demand exceeds a nominal output power of the power adapter 8. As described above, the power is restricted to a third power level of 4.5 W, for example.

In the example, the third power level, with a power output of 4.5 W, corresponds to a lowest standard-conform power level. If the consumption in or on the computer system 1 further increases, and if the voltage monitoring device 9 again detects a drop of the supply voltage U via the measuring line 13, the voltage monitoring device 9 again sends the first warning signal to the interface control device 10 via the first signal line 14. Thereupon, power output from the computer system 1 to the peripheral device 3 via the interface 2 is interrupted. For this purpose, an electronic switch 17 on the signaling circuit 16 is used in this example. The electronic switch 17, however, can also be located at another suitable place in the computer system 1, or an alternative deactivation mechanism can be implemented for that purpose.

If the connection between the computer system 1 and the peripheral device 3 is disconnected and re-established, and if the peripheral device is recognized by the computer system 1 anew, or if a restart of the computer system 1 is performed, the output power is reset to the first power level of 15 W, for example. A detailed procedure of the restriction is described further below with reference to FIG. 2.

A circuit of pull-up resistors and transistors can, for example, be used as the signaling circuit 16 that, on the basis of at least one digital signal, adjusts an auxiliary voltage to a variety of predetermined control voltages. These control voltages correspond to the control voltages of the USB Type-C specification and therefore clearly communicate the available power to the peripheral device 3, via the signaling line 6. If an auxiliary voltage of 5V is used, the following resistance values are used in the signaling circuit 16 for the power levels described above:

1^{st} power level (15 W): 10 kΩ
2^{nd} power level (7.5 W): 22 kΩ
3^{rd} power level (4.5 W): 56 kΩ.

FIG. 1 illustrates a computer system 1 with an interface 2 operated as described above. Of course, more than one interface 2 can be operated on a computer system 2. In this example, it is advantageous to assign priorities to the interfaces 2 and perform the restriction of the power output in accordance with the priorities.

In addition, implementations are possible in which a separate signaling circuit 16 is omitted. The computer system 1 communicates the available power to the peripheral device 3 via the interface control device 10. In this example, the signaling line 6 can be dispensed with and the power level can be communicated via a communication channel signaling. Such a solution is thus independent of the USB Type-C specification specifically described-above and can be used for other interfaces that support a power output. This implementation is particularly suitable for an operation of an interface 2 according to the Power Delivery Specification. In this example, a Power Delivery Controller is particularly suitable as the interface control device 10. Alternatively, our systems and methods can also be used with other interfaces via which a power is provided such as, for example, interfaces supporting Power Over Ethernet, e.g. pursuant to the IEEE 802.3af, IEEE 802.3at or IEEE 802.3bt standard, or serial interfaces supporting a power output.

FIG. 2 illustrates a state diagram of a method of restricting the power output via at least one interface of a computer system according to an example.

First, for example, after connecting a peripheral device 3 to the interface 2 of the computer system 1 according to FIG. 1, or after a start of the computer system 1 and a subsequent recognition of the peripheral device 3 on the interface 2, the system 1 is in a state Z1. In this state Z1, the computer system 1 provides a maximum power on the interface 2 for the peripheral device 3 according to the first power level of 15 W, for example.

If a drop of the supply voltage U below a first threshold value G1 is detected in monitoring the magnitude of the supply voltage U by the voltage monitoring device 9 in the computer system 1, the system 1 proceeds to a second state Z2. In the described method, the computer system 1 continues to output the maximum power to the peripheral device 3, e.g. 15 W, via the interface 2, corresponding to the first power level.

If the voltage monitoring device 9 detects an increase in supply voltage U above the threshold value G1 while the system is in the Z2 state, the system is reset to the initial state Z1. This prevents that temporal power peaks or glitches cause a restriction of the power output via the interface 2. Temporal power peaks cause a temporal drop of the supply voltage U, which, however, does not compromise operation of the computer system 1.

If the voltage monitoring device 9 detects no increase of the supply voltage U above the first threshold value G1 over a certain time T1, e.g. 15 milliseconds, the power output via the interface 2 is temporarily deactivated in a state Z3. This results in that the supply voltage U increases again above the first threshold value G1. If this increase of the supply voltage U of the voltage monitoring device 9 is detected during a time T2, e.g. 3 seconds, the system goes into a state Z4. In this example, the power output via the interface 2 is temporarily deactivated in state Z3 to ensure sufficient time for a communication of the computer system 1 with the peripheral device 3 about the upcoming restriction of the power output.

An alternative implementation is possible without temporarily deactivating the power output via the interface 2. Thus, state Z3 is optional. The system can transition from state Z2 directly to state Z4 if no automatic increase of the voltage U above the first threshold value G1 is detected during time T1.

In state Z4, the computer system 1 delivers a restricted power corresponding to a second power level of e.g. 7.5 Watts via the interface 2. If consumption at the computer system 1 increases further, the supply voltage U drops again below the first threshold value G1. This drop is again detected by the voltage monitoring device 9. The system goes into a state Z5. In this state, as in state Z2, a certain time T1 elapses to check whether the supply voltage U increases above the first threshold value G1 again. If so, the system is reset into state Z4 with a restricted power output of 7.5 W. If this increase of the supply voltage U above the first threshold value G1 is not detected over the time T1 in state Z5, power output via the interface 2 is interrupted in a state Z6.

In the state diagram described in FIG. 2, the third power level of FIG. 1 is omitted. The method of FIG. 2 can, however, also be performed with three or more different power levels until a lowermost power level in which power is output from the computer system 1 to the peripheral device 3 is reached, and in an anew drop of the supply voltage U, the power output is interrupted.

States Z1 and Z4 are static states in which the computer system permanently provides a supply voltage via the interface 2 as long as no drop of the supply voltage U is detected. Z6 likewise is a static state in which the power output via the interface 2 is interrupted. A reset of the static states Z4 and Z6 with a lowered or interrupted power output to the static state Z1 with an unrestricted power output is possible via a disconnection of the connection and an anew plug-in of the peripheral device 3, or via a restart of the computer system 1.

If the voltage monitoring device 9 does not detect an increase of the supply voltage U above the first threshold value G1 in the state Z3 for a time T3, e.g. 10 milliseconds, although the power output via interface 2 is temporarily deactivated, the system goes into a state Z7. T3 thus corresponds to a fraction of time T2. In state Z3, the power output is temporarily deactivated for 3 seconds. If, within 10 milliseconds during the deactivation, no increase of the voltage U above the threshold value G1 is detected, the system goes into state Z7, but if an increase of the voltage U above the threshold G1 is detected, the system goes into state Z4 after an elapse of 3 seconds. In state Z7, the computer system 1 is emergency shut-off by an emergency shutdown component 11 to prevent an overload of the power adapter 8 of computer system 1.

States Z2, Z3 and Z5 are non-static states respectively taken for only the predetermined times T1 or T2 or T3, respectively. In this example, the following values are selected for times T1, T2 and T3. Other suitable values are of course possible.

T1=5 milliseconds
T2=3 seconds
T3=10 milliseconds

The system goes into a state Z7 from each of states Z1 to Z6, and is thus emergency shut-off if the voltage monitoring device 9 detects a drop of the supply voltage U below a second threshold value G2.

1.-15. (canceled)

16. A computer system having at least one interface comprising:
at least one voltage monitoring device, and
at least one interface control device including a signaling circuit,
wherein the interface control device is configured to restrict a power output via the interface to a predetermined power level if the voltage monitoring device detects a drop of a supply voltage of the computer system below a first threshold value, and the signaling circuit is configured to signalize the restriction of the power output to a peripheral device.

17. The computer system according to claim 16, wherein the at least one interface is at least one USB Type-C interface.

18. The computer system according to claim 16, further comprising a power supply unit, wherein the supply voltage of the computer system is provided by the power supply unit.

19. The computer system according to claim 18, wherein the power supply unit comprises a power adapter.

20. The computer system according to claim 16, wherein the voltage monitoring device is configured, in a drop of the supply voltage below the first threshold value in the computer system, to send at least one first warning signal to restrict the power output to the interface control device.

21. The computer system according to claim 16, wherein the voltage monitoring device is configured to send a second warning signal to an emergency shutdown component of the computer system if the supply voltage drops below a second threshold value and the emergency shutdown component is configured to perform an emergency shutdown of the computer system upon receiving the second warning signal.

22. The computer system according to claim 16, wherein the interface includes at least one supply line and at least one signaling line, and the interface control device connects to the at least one supply line and the at least one signaling line.

23. The computer system according to claim 17, wherein the interface is configured for different power outputs in accordance with the Power Delivery Specification.

24. A method of restricting power output via at least one interface of a computer system, comprising:
monitoring a magnitude of a supply voltage in the computer system, and
restricting the power output via the at least one interface to a predetermined power level if a drop of the supply voltage below a first threshold value is detected, wherein the restriction of the power output is signaled to a peripheral device connected to the at least one interface by a signaling circuit.

25. The method according to claim 24, wherein one of a plurality of different, predetermined power levels is selected for the power output.

26. The method according to claim 25, wherein the plurality of the different power levels include a power output of 15 W, 7.5 W and 4.5 W.

27. The method according to claim 25, wherein the plurality of different power levels include a power level, the selection of which interrupts the power output.

28. The method according to claim 24, wherein a second warning signal is sent if a drop of the supply voltage below a second threshold is detected, and the computer system, upon receiving the second warning signal, is emergency shut-off.

29. The method according to claim 24, wherein the power output via the interface is temporarily deactivated after the first warning signal has been received by the interface control device and before the predetermined power level is provided.

30. The method according to claim 24, wherein, after detecting the drop of the supply voltage, restriction of the supply voltage is delayed by a time T to check whether the supply voltage rises again above the first threshold value and the power output continues without restriction.

31. The method according to claim 24, including the switching from the predetermined power level to a non-restricted power output if a connecting of the peripheral device to the interface or a restart of the computer system is detected.
